(19) United States
(12) Patent Application Publication
(10) Pub. No.: US 2010/0310280 A1
(43) Pub. Date: Dec. 9, 2010

(54) SHEET SKEW CORRECTING DEVICE OF IMAGE FORMING APPARATUS

(75) Inventors: Hirofumi Kondo, Kanagawa (JP); Yoshinori Tsueda, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/790,501

(22) Filed: May 28, 2010

Related U.S. Application Data
(60) Provisional application No. 61/183,639, filed on Jun. 3, 2009.
(60) Provisional application No. 61/184,707, filed on Jun. 5, 2009.

(51) Int. Cl. G03G 15/16; B65H 5/06; B65H 9/00

(52) U.S. Cl. 399/297; 271/226; 271/264; 271/273; 271/274; 399/395

(57) ABSTRACT

A sheet skew correcting device includes a first sheet conveyance unit which a conveyance force at a center side is smaller than a conveyance force at a first side, a second sheet conveyance unit which is adjacent to the first sheet conveyance unit across the center and a conveyance force at the center side is smaller than a conveyance force at a second side, a first drive unit to drive the first rotator, a second drive unit to drive the third rotator, a detection unit to detect an inclination of the sheet, and a control unit to control the first drive unit and the second drive unit based on a detection result of the detection unit.

### CROSS-REFERENCE TO RELATED APPLICATION

This application is based upon and claims the benefit of priority from Provisional U.S. Applications 61/183,639 filed on Jun. 3, 2009, and 61/184,707 filed on Jun. 5, 2009, the entire contents of which are incorporated herein by reference.

### TECHNICAL FIELD

An embodiment relates to sheet conveyance in an image forming apparatus or the like, and particularly to a sheet skew correcting device to correct skew of a sheet.

### BACKGROUND

An image forming apparatus includes a sheet conveying device to correct skew of a sheet supplied to a printer unit or a scanner unit. For example, the sheet conveying device detects skew of a sheet by a sensor, and gives a rotation speed difference to two pairs of right and left conveyance rollers based on the detection result to correct the quantity of the sheet skew. It is demanded that the sheet conveying device corrects skew of a sheet in order to support widths of various sizes of sheets.

It is desired to develop a sheet skew correcting device which supports widths of various sizes of sheets without using a dedicated drive mechanism and certainly corrects the skew of a sheet.

### DESCRIPTION OF THE DRAWINGS

FIG. 1 is a schematic structural view showing a copying machine including a registration device of a first embodiment;

FIG. 2 is a schematic structural view in which the registration device of the first embodiment is seen from above;

FIG. 3 is a schematic explanatory view in which the registration device of the first embodiment is seen from a conveyance direction of a sheet;

FIG. 4 is a schematic structural view showing a registration roller of the first embodiment;

FIG. 5 is a schematic explanatory view showing the difference in pressing forces of compression springs of the first embodiment;

FIG. 6 is a schematic explanatory view for explaining the first embodiment and showing shear force generated in a sheet when conveyance forces of conveyance rollers are all equal to one another;

FIG. 7 is a schematic explanatory view for explaining the first embodiment and showing shear force generated in a sheet when conveyance forces of conveyance rollers close to the center are made smaller than conveyance forces of conveyance rollers close to both sides;

FIG. 8 is a schematic explanatory view for explaining the first embodiment and showing a flexure caused in a sheet by shear force;

FIG. 9 is a schematic explanatory view for explaining the first embodiment and showing a detection error of a sensor due to the flexure of the sheet;

FIG. 10 is a schematic functional block diagram showing a control system of the first embodiment;

FIG. 11 is a flowchart showing skew correction of the first embodiment;

FIG. 12 is a schematic explanatory view showing a state where a sheet passes through a first skew detection unit in the first embodiment;

FIG. 13 is a schematic explanatory view showing a state where the sheet passes through a second skew detection unit in the first embodiment;

FIG. 14 is a schematic explanatory view in which a registration device of a second embodiment is seen from above; and

FIG. 15 is a schematic explanatory view in which a registration device of a modified example is seen from a conveyance direction of a sheet.

### DETAILED DESCRIPTION

According to an embodiment, a sheet skew correcting device includes a first sheet conveyance unit which has a drive rotating first rotator and a second rotator to nip a sheet together with the first rotator and to be driven, and in which a conveyance force at a center side in a traveling direction of the sheet is smaller than a conveyance force at a first side in the traveling direction, a second sheet conveyance unit which has a drive rotating third rotator and a fourth rotator to nip the sheet together with the third rotator and to be driven, which is adjacent to the first sheet conveyance unit across the center in the traveling direction of the sheet, and a conveyance force at the center side in the traveling direction of the sheet is smaller than a conveyance force at a second side in the traveling direction, a first drive unit to drive the first rotator, a second drive unit to drive the third rotator, a detection unit to detect an inclination of the sheet and a control unit to control the first drive unit and the second drive unit.

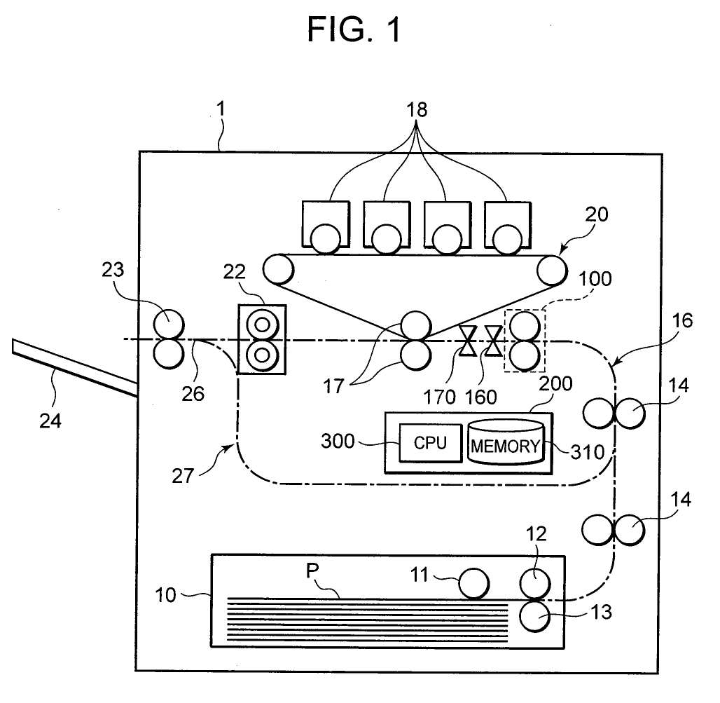

Hereinafter, embodiments will be described. FIG. 1 shows a copying machine 1 as an image forming apparatus of a first embodiment, which includes a registration device 100 as a sheet skew correcting device. In the copying machine 1, a pickup roller 11 takes out a sheet P stacked on a paper feed tray 10, and a feed roller 12 and a reverse roller 13 separates the sheet P one by one and send the sheet P to a guide roller pair 14. The guide roller pair 14 conveys the sheet P along a paper feed guide 16.

The copying machine 1 includes the registration device 100 as the sheet skew correcting device at the downstream side of the guide roller pair 14. The registration device 100 corrects the skew of the sheet P and adjusts the posture of the sheet P reaching a transfer device 17.

In the copying machine 1, for example, four image forming stations 18 as an image forming unit overlappingly form toner images of four colors of yellow (Y), magenta (M), cyan (C) and black (Y) on an intermediate transfer belt 20 as an image carrier. In the copying machine 1, the transfer device 17 transfers the toner images formed on the intermediate transfer belt 20 to the sheet P.

In the copying machine 1, a fixing device 22 heats, presses and fixes the toner images to the sheet P. After fixing, in the copying machine 1, a paper discharge roller 23 discharges the sheet P to a paper discharge tray 24. When a print operation is double-sided printing, the copying machine 1 returns the sheet P having a toner image formed on a first surface of the sheet P to the paper feed guide 16 from a gate 26 through a double-sided guide 27.

Similarly to the toner image formation to the first surface, in the copying machine 1, the registration device 100 corrects the skew of the sheet P and adjusts the posture of the sheet P in the transfer device 17. In the copying machine 1, toner images of four colors of yellow (Y), magenta (M), cyan (C) and black (Y) for the second surface formed by the four image forming stations 18 are overlappingly formed on the intermediate transfer belt 20. In the copying machine 1, the transfer device 17 transfers the toner images for the second surface formed on the intermediate transfer belt 20 to the second surface of the sheet P. In the copying machine 1, the fixing device 22 heats, presses and fixes the toner images to the second surface of the sheet P, and the paper discharge roller 23 discharges the sheet P having the toner images on both the surfaces to the paper discharge tray 24.

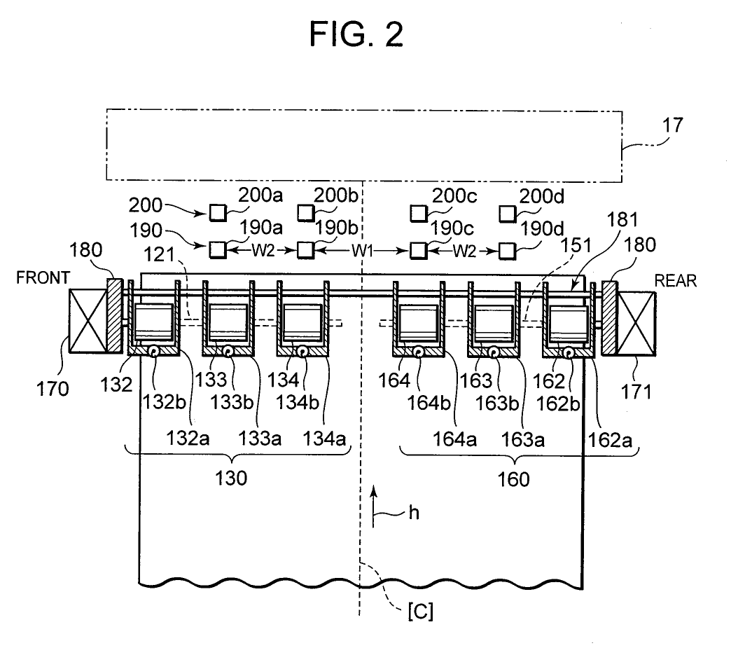

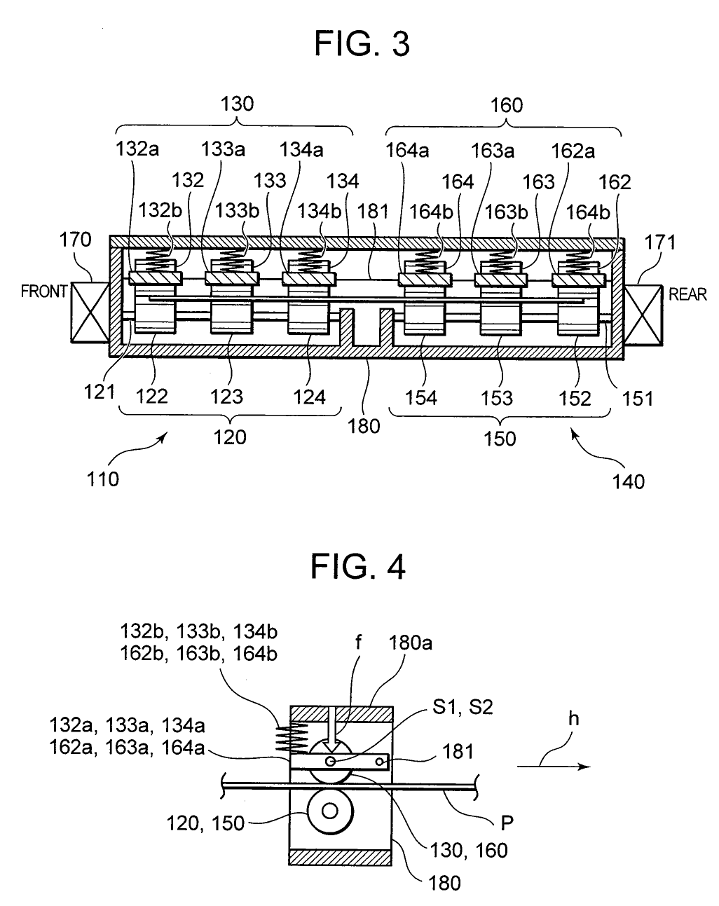

As shown in FIG. 2 and FIG. 3, the registration device 100 includes for example a front registration roller 110 as a first sheet conveyance unit at the front side of the copying machine 1 with respect to the traveling direction of the sheet P as an arrow h direction. The registration device 100 includes for example a rear registration roller 140 as a second sheet conveyance unit at the rear side of the copying machine 1 with respect to the traveling direction of the sheet P as the arrow h direction.

In the registration device 100, the front registration roller 110 and the rear registration roller 140 are arranged symmetrically with respect to the center [C] in the traveling direction of the sheet P. The front registration roller 110 and the rear registration roller 140 have lengths in the width direction of the sheet P. Since the lengths are provided in the width direction of the sheet P, the front registration roller 110 and the rear registration roller 140 convey sheets including narrow width sheets and wide width sheets. The front registration roller 110 and the rear registration roller 140 conveys sheets having sizes of, for example, from post card size (100 mm×148 mm) to JIS standard A3 size (297 mm×420 mm).

The front registration roller 110 includes a first registration roller 120 as a first rotator and a second registration roller 130 as a second rotator. The rear registration roller 140 includes a third registration roller 150 as a third rotator and a fourth registration roller 160 as a fourth rotator.

The surfaces of the first registration roller 120 and the third registration roller 150 are made of, for example, rubber material such as ethylene propylene rubber (EPDM). The surfaces of the second registration roller 130 and the fourth registration roller 160 are made of resin material such as, for example, polyacetal (POM) having a smaller friction coefficient than that of the EPDM. Incidentally, the material of the first registration roller 120 and the third registration roller 150 and the material of the second registration roller 130 and the fourth registration roller 160 are not limited. For example, the surfaces of the first registration roller 120 and the third registration roller 150 may be formed of rubber material, and the surfaces of the second registration roller 130 and the fourth registration roller 160 may be formed of metal such as stainless (SUS 304).

The registration device 100 includes a front motor 170 to drive the first registration roller 120 and a rear motor 171 to drive the third registration roller 150. The front registration roller 110 and the rear registration roller 140 are driven independently from each other. The second registration roller 130 is driven by the sheet P traveling between the first registration roller 120 and the second registration roller 130. The fourth registration roller 160 is driven by the sheet P traveling between the third registration roller 150 and the fourth registration roller 160.

The registration device 100 includes a first skew detection unit 190 as a detection unit at a position located downstream of the front registration roller 110 and the rear registration roller 140 in the traveling direction of the sheet P and before the transfer device 17. Further, the registration device 100 includes a second skew detection unit 200 as a detection unit at a position located downstream of the first skew detection unit 190 and before the transfer device 17.

The first skew detection unit 190 includes four first sensors 190a, 190b, 190c and 190d arranged in a direction perpendicular to the traveling direction of the sheet P. The second skew detection unit 200 includes four second sensors 200a, 200b, 200c and 200d arranged in the direction perpendicular to the traveling direction of the sheet P. In the first skew detection unit 190 and the second skew detection 200, the first sensors 190a, 190b, 190c and 190d and the second sensors 200a, 200b, 200c and 200d are arranged so that passing of sheets P having widths of from, for example, narrow post card size width to wide JIS standard A3 size width can be detected.

For example, the center first sensors 190b and 190c or the second sensors 200b and 200c are spaced by a distance W1. The first sensors 190a and 190b, the first sensors 190c and 190d, the second sensors 200a and 200b, or the second sensors 200c and 200d are spaced by a distance W2. The distance W1 is set to, for example, 75% to 85% of the width of the post card size. The distance W2 is set so that for example, the width (W1+W2×2) is 75% to 85% of the width when the sheet of JIS standard A3 size is longitudinally conveyed.

For example, an optical non-contact sensor is used for the first sensors 190a, 190b, 190c and 190d and the second sensors 200a, 200b, 200c and 200d.

The registration device 100 includes a controller 260 as a control unit to determine an inclination of the sheet P from detection results of the first skew detection unit 190 and the second skew detection unit 200 and to control the front motor 170 and the rear motor 171.

A pair of the first registration roller 120 and the second registration roller 130 nip and convey the sheet P. A pair of the third registration roller 150 and the fourth registration roller 160 nip and convey the sheet P. The first registration roller 120 includes, for example, three first rollers 122, 123 and 124 along a first shaft 121. The third registration roller 150 includes, for example, three third rollers 152, 153 and 154 along a third shaft 151.

A fixed frame 180 supports the first shaft 121 and the third shaft 151. The front motor 170 drives and rotates the first rollers 122 to 124 through the first shaft 121. The rear motor 171 drives and rotates the third rollers 152 to 154 through the third shaft 151.

The second registration 130 includes three second rollers 132, 133 and 134 respectively opposite to the first rollers 122 to 124. The fourth registration roller 160 includes three fourth rollers 162, 163 and 164 respectively opposite to the third rollers 152 to 154.

The second rollers 132 to 134 are rotatably supported by a roller support shaft sl of roller support frames 132a to 134a as a first support frame. The fourth rollers 162 to 164 are rotatably supported by a roller support shaft s2 of roller support frames 162a to 164a as a second support frame. The roller support frames 132a to 134a, and 162a to 164a are rotatably supported by the fixed frame 180 through a link shaft 181 as a first shaft and a second shaft. The roller support frames may be individually attached to the fixed frame without using the common link shaft.

As shown in FIG. 4, compression springs 132b to 139b, and 162b to 164b as a pressing unit intervene between an upper surface 180a of the fixed frame 180 and front ends of the roller support frames 132a to 134a, and 162a to 164a. The compression springs 132b to 134b or 162b to 164b respectively press the roller support frames 132a to 134a or 162a to 164a in the directions toward the first rollers 122 to 129 or the third rollers 152 to 154 while the link shaft 181 is used as the rotation center.

The roller support frames 132a to 134a or 162a to 164a are respectively pressed in the directions toward the first rollers 122 to 124 or the third rollers 152 to 154, so that the second rollers 132, 133 and 134 or the fourth rollers 162, 163 and 164 are respectively pressed in the directions toward the first rollers 122 to 124 or the third rollers 152 to 154. The pressing unit may be a coil spring or the like provided between the roller support frame and the link shaft.

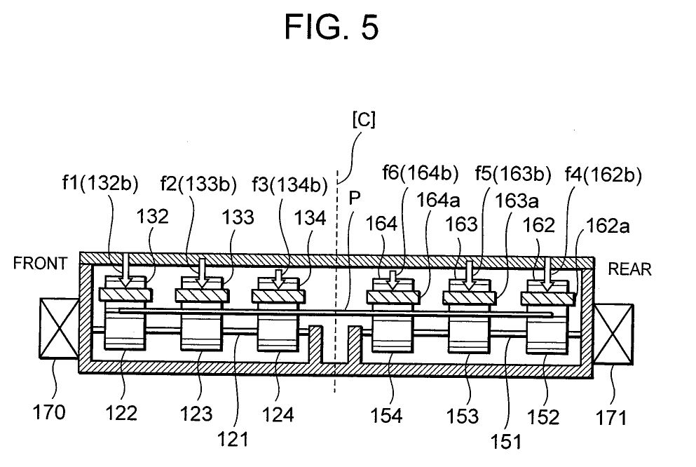

As shown in FIG. 5, magnitudes of pressing forces f1, f2 and f3 of the compression springs 132b to 134b are made f1 >f2>f3. The pressing forces of the compression springs 132b to 134b become small from the front side as the first side in the conveyance direction of the sheet P to the center [C] of the sheet P. The magnitudes of pressing forces f4, f5 and f6 of the compression springs 162b to 164b are made f4>f5>f6. The pressing forces of the compression springs 162b to 164b become small from the rear side as the second side in the conveyance direction of the sheet P to the center [C] in the traveling direction of the sheet.

The pressing forces of the compression springs 134b and 164b at the side close to the center [C] in the traveling direction of the sheet P are smallest, and the pressing forces of the compression springs 132b and 162b at the side close to the front side and the rear side of both sides in the traveling direction of the sheet P are largest.

By changing the pressing forces of the compression springs 132b to 134b and the compression springs 162b to 164b, the front registration roller 110 or the rear registration roller 140 changes the conveyance force (friction force) of the sheet P along the direction perpendicular to the traveling direction of the sheet P.

In this embodiment, the conveyance force of the sheet P close to the center [C] in the traveling direction of the sheet P caused by the front registration roller 110 or the rear registration roller 140 is made smaller than the conveyance force at the front side and the rear side in the traveling direction of the sheet P, and the flexure caused at the time of conveyance of the sheet P is suppressed. The flexure caused in the sheet P is suppressed to suppress the reduction of detection precision of the first skew detection unit 190 and the second skew detection unit 200.

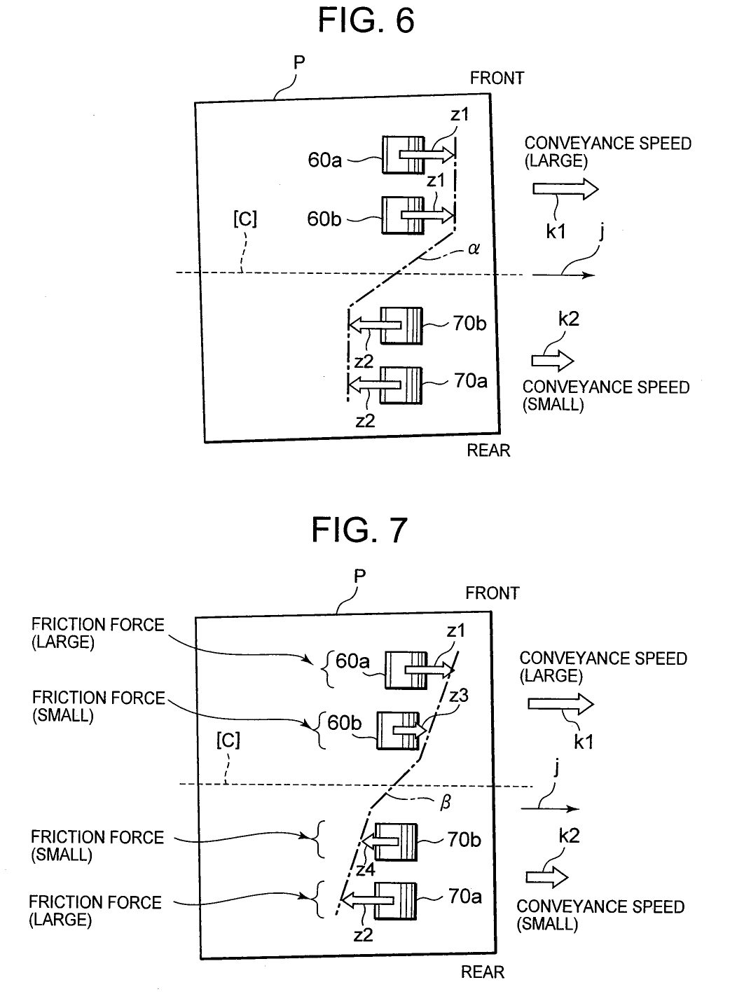

With reference to FIG. 6 and FIG. 7, a description will be made to the principle in which the flexure of the sheet P can be suppressed by causing the conveyance force of the sheet P close to the center [C] in the traveling direction of the sheet P to become smaller than the conveyance force at both sides in the traveling direction of the sheet P at the time of conveyance of the sheet P.

(1) For example, conveyance forces of two conveyance roller pairs 60a and 60b at the front side and two conveyance roller pairs 70a and 70b at the rear side are made all equal to one another, and the sheet P is conveyed in an arrow j direction.

FIG. 6 shows friction forces generated in the sheet P when a conveyance speed k1 by the front side conveyance roller pairs 60a and 60b is larger than a conveyance speed k2 by the rear side conveyance roller pairs 70a and 70b. Since the conveyance forces of the conveyance roller pairs 60a and 60b and the conveyance roller pairs 70a and 70b are all equal to one another, the sheet P receives a friction force z1 in the conveyance direction by the front side conveyance roller Pairs 60a and 60b, and receives a friction force z2 in the direction opposite to the conveyance direction and having the same magnitude as the friction force z1 by the rear side conveyance roller pairs 70a and 70b.

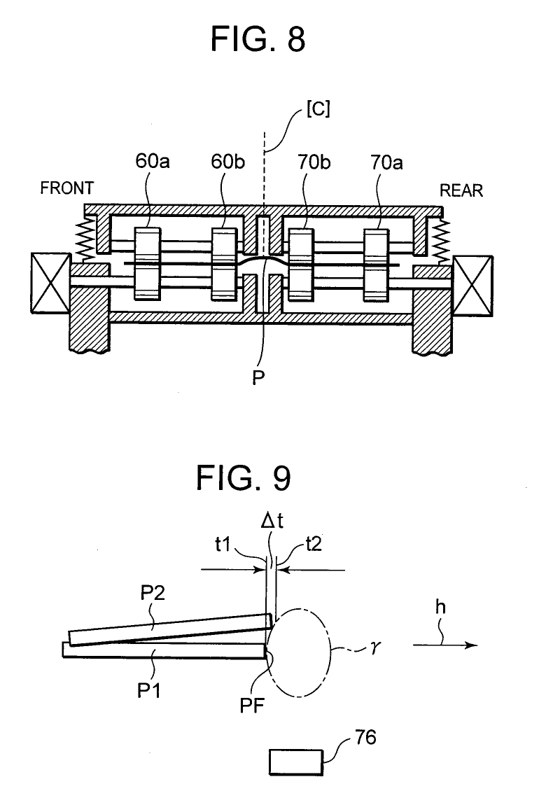

Thus, the sheet P is pulled by the friction force z1 and the friction force z2 having directions opposite to each other, and a large shear force indicated by an alternate long and short dash line α in FIG. 6 is generated in the vicinity of the center [C]. By this shear force, the vicinity of the center [C] of the sheet P is flexed as shown in FIG. 8. The distance between an optical non-contact sensor 76 and the sheet P is changed by the flexure, and there is a fear that the detection precision of the sensor 76 is reduced.

(2) Differently from the above (1), the conveyance forces of the conveyance roller pairs 60b and 70b close to the center [C] are made smaller than the conveyance forces of the conveyance roller pairs 60a and 70a close to both sides, and the sheet P is conveyed in the arrow j direction.

FIG. 7 shows friction forces generated in the sheet P when the front side conveyance speed k1 is larger than the rear side conveyance speed k2. The sheet P receives a friction force z1 in the conveyance direction from the conveyance roller pair 60a having a large conveyance force at the front side, and receives a friction force z3 smaller than the friction force z1 and having the same direction as the friction force z1 from the conveyance roller pair 60b having a small conveyance force. The sheet P receives a friction force z2 having an opposite direction to and a same magnitude as the friction force z1 from the conveyance roller pair 70a having a large conveyance force at the rear side, and receives a friction force z4 having an opposite direction to and a same magnitude as the friction force z3 from the conveyance roller pair 70b having a small conveyance force.

Accordingly, as indicated by an alternate long and short dash line β in FIG. 7, a shear force generated in the sheet P in the vicinity of the center [C] is small as compared with the alternate long and short dash line a of FIG. 6. Since the shear force is small, the flexure of the sheet P in the vicinity of the center [C] of the sheet P becomes small.

The flexure caused in the sheet P has a large influence on the detection precision of the first skew detection unit 190 and the second skew detection unit 200. For example, FIG. 9 shows influence when, for example, an optical non-contact sensor is used for the first skew detection unit 190 and the second skew detection unit 200. An optical non-contact sensor 76 includes a specific detection area. For example, it is assumed that the detection area of the sensor 76 is a range indicated by an alternate long and short dash line γ. When the front end of the sheet reaches the detection area γ, the sensor 76 receives the reflected light from the front end of the sheet and detects the arrival of the sheet P.

When the sheet is not flexed as indicated by P1, the sensor 76 detects a sheet front end PF at timing tl. On the other hand, even if the sheet enters the detection position of the sensor 76 in the same skew state, when the sheet is flexed as indicated by P2, a time when the front end of the sheet reaches the detection area γ is delayed. When the sheet is flexed, the sensor 76 detects the sheet front end at timing t2. When the sheet is flexed, as compared with the case where it is not flexed, the detection timing is delayed by Δt, and the sheet detection precision of the sensor 76 is reduced. As the flexure of the sheet becomes large, the delay Δt of the detection timing becomes large. Thus, in order to improve the detection precision of the sensor 76, it is necessary to suppress the flexure of the sheet.

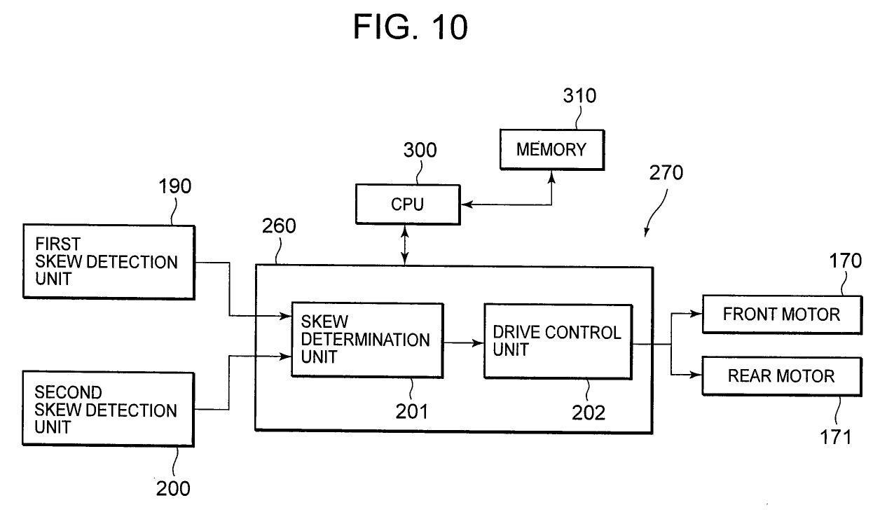

FIG. 10 shows a control system 270 of the front motor 170 and the rear motor 171. A controller 260 includes a skew determination unit 201 and a drive control unit 202. The controller 260 is connected to a CPU 300 to control the whole copying machine 1, and realizes a skew determination function and a drive control function. The CPU 300 includes a memory 310. The CPU 300 realizes various functions by executing programs stored in the memory 310. The memory 310 can be composed of, for example, a RAM (Random Access Memory), a ROM (Read Only Memory), a DRAM (Dynamic Random Access Memory), a SRAM (Static Random Access Memory), a VRAM (Video RAM) or the like, and stores various information and programs used in the copying machine 1 including the registration device 100.

The skew determination unit 201 determines the quantity of skew of the sheet P based on the detection of the front end of the sheet P or the rear end of the sheet P obtained from the first skew detection unit 190 and the second skew detection unit 200. The drive control unit 202 individually controls the front motor 170 and the rear motor 171 so as to reduce the quantity of skew of the sheet P determined by the skew determination unit 201.

Next, a description will be made to a traveling operation of the sheet P when the sheet P is aligned by the registration device 100 and is conveyed in the direction toward the transfer device 17.

At the time of printing, the image forming station 18 forms a toner image on the intermediate transfer belt 20. The controller 260 controls the registration device 100, corrects the skew of the sheet P, adjusts the posture of the sheet P, and conveys the sheet P to the transfer device 17 in synchronization with the arrival of the toner image on the intermediate transfer belt 20 at the transfer device 17. That is, the pickup roller 11 synchronizes with the toner image on the intermediate transfer belt 20 and takes out the sheet P from the paper feed tray 10. The feed roller 12 and the reverse roller 13 separate the sheet P one by one, and the guide roller pair 14 sends the sheet P to the registration device 100.

In the registration device 100, the controller 260 drives and controls the front motor 170 and the rear motor 171, controls the rotation of the first registration roller 120 and the third registration roller 150, and corrects the skew of the sheet P traveling in the arrow h direction. When the conveyance speeds of the sheet P by the front registration roller 110 and the rear registration roller 140 are different, the shear force is generated in the vicinity of the center [C] of the sheet P by the friction force in the arrow h direction received by the sheet P from the front registration roller 110 and the friction force in the reverse direction to the arrow h direction received from the rear registration roller 140.

However, in the front registration roller 110, the magnitudes of the pressing forces of the compression springs 132b to 134b become small toward the center [C] of the sheet P like f1 >f2>f3, and the conveyance force of the pair of the first roller 124 and the second roller 134 close to the center [C] is small as compared with the front side. In the rear registration roller 140, the magnitudes of the pressing forces of the compression springs 162b to 164b become small toward the center [C] of the sheet P like f4>f5>f6, and the conveyance force of the pair of the third roller 154 and the fourth roller 164 close to the center [C] is small as compared with the rear side.

Accordingly, the shear force generated in the vicinity of the center [C] of the sheet P is weakened by the speed difference between the front registration roller 110 and the rear registration roller 140, and the flexure of the sheet P becomes small. The error At of the detection timing of the sheet P by the first skew detection unit 190 and the second skew detection unit 200 becomes small. As a result, the first skew detection unit 190 and the second skew detection unit 200 detect the sheet P at high precision.

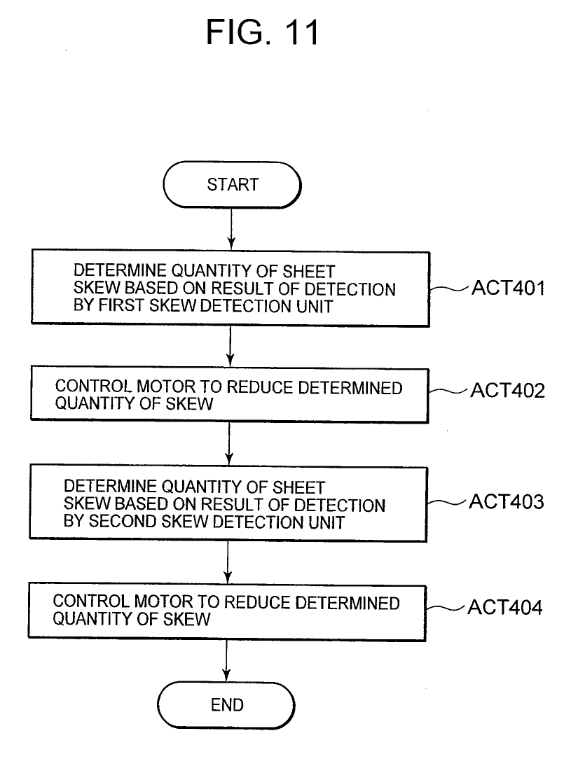

The first skew detection unit 190 and the second skew detection unit 200 input the detection results to the skew determination unit 201 of the controller 260. The controller 260 controls the front motor 170 and the rear motor 171 based on the detection results of the first skew detection unit 190 and the second skew detection unit 200. A flowchart of FIG. 11 shows the control of the front motor 170 and the rear motor 171. When the sheet P reaches the first skew detection unit 190, the four first sensors 190a, 190b, 190c and 190d arranged in the direction perpendicular to the traveling direction of the sheet P respectively input the detection results to the skew determination unit 201 in synchronization with the arrival of the sheet P.

The skew determination unit 201 determines the quantity of skew of the sheet P based on the detection results of the front end of the sheet P from the first skew detection unit 190 (ACT 401).

For example, when the sheet P is skewed as shown in FIG. 12, the rear side first sensor 190d, which the sheet front end first reaches, is first turned ON. Thereafter, the first sensors 190c, 190b and 190a are successively turned ON toward the front side. The skew determination unit 201 determines the quantity of skew (θ1) of the sheet from differences between times when the first sensors 190d, 190c, 190b and 190a are successively turned ON from the rear side, distances W1 and W2 between the respective first sensors 190d, 190c, 190b and 190a, and an average conveyance speed of the sheet P.

The drive control unit 202 controls the front motor 170 and the rear motor 171 so as to correct the quantity (θ1) of skew determined by the skew determination unit 201 based on the detection results of the first skew detection unit 190, and controls the rotation drive of the first registration roller 120 and the third registration roller 150 (ACT 402).

The drive control unit 202 obtains a peripheral speed difference (V1) between the front registration roller 110 and the rear registration roller 140 required to cancel the quantity of skew (θ1) determined by the skew determination unit 201 in, for example, the time in which the sheet P reaches the transfer device 17 from the first skew detection unit 190. The drive control unit 202 controls the front motor 170 and the rear motor 171 respectively so that the peripheral speed difference between the front registration roller 110 and the rear registration roller 140 becomes the obtained peripheral speed difference (V1).

The drive control unit 202 controls the front motor 170 and the rear motor 171 respectively, and the registration device 100 conveys the sheet P to the second skew detection unit 200 while correcting the quantity of skew (θ1) of the sheet P.

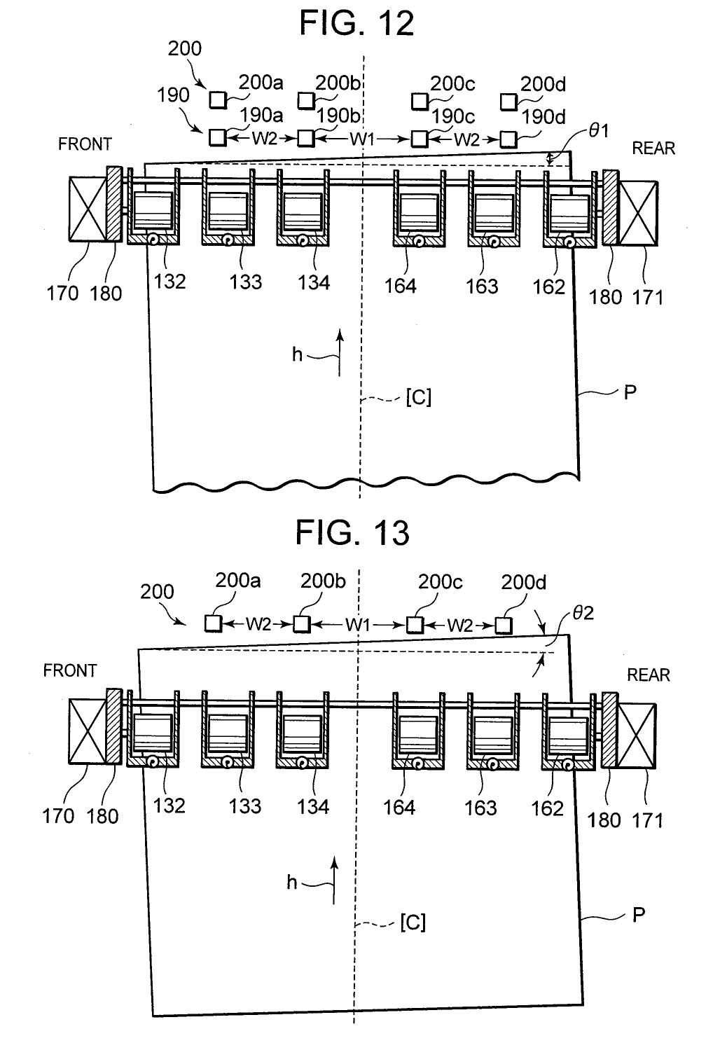

Thereafter, as shown in FIG. 13, when the sheet reaches the second skew detection unit 200, the four second sensors 200a, 200b, 200c and 200d arranged in the direction perpendicular to the traveling direction of the sheet P respectively input the detection results to the skew determination unit 201 in synchronization with the arrival of the sheet P. The skew determination unit 201 determines the quantity of skew of the sheet P based on the detection results of the front end of the sheet P from the second skew detection unit 200 (ACT 403).

Similarly to ACT 401, the skew determination unit 201 determines the quantity of skew (θ2) of the sheet in the second skew detection unit 200 from differences between times when the second sensors 200a, 200b, 200c and 200d are respectively turned ON in accordance with the inclination of the sheet P, distances W1 and W2 between the respective second sensors 200a, 200b, 200c and 200d, and the average conveyance speed of the sheet P.

The drive control unit 202 controls the front motor 170 and the rear motor 171 based on the detection result of the second skew detection unit 200 so as to correct the quantity of skew (θ2) determined by the skew determination unit 201 and further controls the rotation drive of the first registration roller 120 and the third registration roller 150 (ACT 404).

Similarly to ACT 402, the drive control unit 202 obtains a peripheral speed difference (V2) between the first registration roller 120 and the third registration roller 150 required to cancel the quantity of skew (θ2) determined by the skew determination unit 201. The drive control unit 202 controls the front motor 170 and the rear motor 171 respectively, so that the peripheral speed difference between the first registration roller 120 and the second registration roller 150 becomes the obtained peripheral speed difference (V2), and finishes the control of the controller 260.

The registration device 100 controls the front motor 170 and the rear motor 171 respectively, and conveys the sheet P to the transfer device 17 while correcting the quantity (θ2) of skew of the sheet P. The front motor 170 and the rear motor 171 are controlled by using the detection result of the first skew detection unit 190, and are further controlled by using the detection result of the second skew detection unit 200, the skew of the sheet P is corrected, and the posture of the sheet P reaching the transfer device 17 is adjusted.

Thereafter, the transfer device 17 transfers the toner image on the intermediate transfer belt 20 to the sheet P reaching the transfer device 17 in synchronization with the toner image on the intermediate transfer belt 20. The copying machine 1 heats, presses and fixes the toner image to the sheet P, discharges the sheet to the paper discharge tray 24, and finishes the print operation.

According to the first embodiment, in the registration device 100, the pressing force of the compression spring 134b of the second roller 134 of the front registration roller 110 close to the center [C] and the pressing force of the compression spring 164 of the second roller 164 of the rear registration roller 140 close to the center [C] are made weak, and the conveyance forces close to the center [C] in the front registration roller 110 and the rear registration roller 140 are made low. By this, the shear force generated in the vicinity of the center [C] of the sheet P by the speed difference between the front registration roller 110 and the rear registration roller 140 is made small, and the flexure caused in the sheet P is made small. As a result, the detection error of the sheet P by the first skew detection unit 190 or the second skew detection unit 200 can be reduced without using a complicated mechanism, and the detection precision of the sheet P by the first skew detection unit 190 or the second skew detection unit 200 can be improved. The controller 260 can control the front motor 170 and the rear motor 171 at high precision based on the high precision detection result, and the registration device 100 can correct the skew of the sheet P at high precision.

Next, a second embodiment will be described. According to the second embodiment, in the first embodiment, the front registration roller and the rear registration roller are slightly inclined with respect to the direction perpendicular to the traveling direction of the sheet. In the second embodiment, the same component as the component described in the first embodiment is denoted by the same reference numeral and its detailed description is omitted.

In this embodiment, as shown in FIG. 14, shafts 110a and 140a of a front registration roller 110 and a rear registration roller 140 of a registration device 100 are inclined by θ3 with respect to an alternate long and short dash line δ perpendicular to a conveyance direction of a sheet P as an arrow h direction. The inclination angle θ3 with respect to the alternate long and short dash line δ is made, for example, 0.1°. The inclination angle θ3 is not limited to this as long as the angle is the same angle for the front registration roller 110 and the rear registration roller 140.

When the shafts 110a and 140a of the front registration roller 110 and the rear registration roller 140 are inclined, the direction of the forces Fa and Fb exerted on the sheet by each of the front registration roller 110 and the rear registration roller 140 becomes the direction deviated from the arrow h direction by θ3. In the forces Fa and Fb, Fa cos θ and Fb cos θ as components in the conveyance direction of the sheet P contribute to the conveyance of the sheet. Since the angle of θ3 is sufficiently as small as θ3=0.1°, most of the forces Fa and Fb contributes to the conveyance of the sheet P.

On the other hand, the forces Fa sin θ and Fb sin θ of the components perpendicular to the sheet conveyance direction also act on the sheet slightly. The forces Fa sin θ and Fb sin θ act to pull the sheet P to both sides from the center [C] of the sheet P. The forces Fa sin θ and Fb sin θ pull the flexure caused in the sheet Pin the vicinity of the center [C] by the speed difference between the front registration roller 110 and the rear registration roller 140 to both sides and reduce the flexure.

The front registration roller 110 and the rear registration roller 140 reduces the conveyance force close to the center [C], reduces the shear force generated in the sheet P in the vicinity of the center [C] since the conveyance speed of the sheet P is different between the front registration roller 110 and the rear registration roller 140, and reduces the flexure of the sheet P. Further, the shafts 110a and 140a of the front registration roller 110 and the rear registration roller 140 are slightly inclined to reduce the flexure of the sheet P. As a result, the first skew detection unit 190 and the second skew detection unit 200 detect the sheet P at high precision.

According to the second embodiment, similarly to the first embodiment, the detection error of the sheet P by the first skew detection unit 190 or the second skew detection unit 200 is reduced without using a complicated mechanism, and the detection precision of the sheet P by the first skew detection unit 190 or the second skew detection unit 200 can be improved. Based on the high precision detection result, the controller 260 can control the front motor 170 and the rear motor 171 at high precision, and the registration device 100 can correct the skew of the sheet P at high precision.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form the apparatus and methods described herein may be made without departing from the spirit of the inventions. The accompanying claims and there equivalents are intended to cover such forms of modifications as would fall within the scope and spirit of the invention.

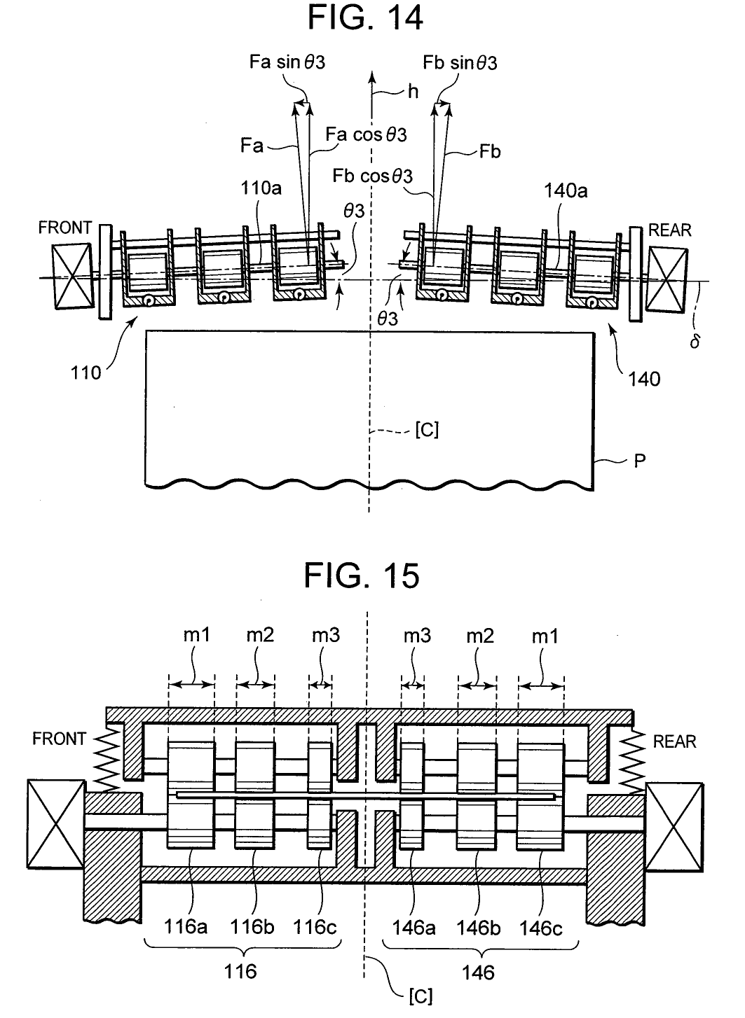

As in a modified example shown in FIG. 15, the pressing forces of plural roller pairs 116a, 116b and 116c of a front registration roller 116 and plural roller pairs 146a, 146b and 146c of a rear registration roller 146 are made constant, while respective roller widths are changed like ml >m2>m3. The roller widths of the roller pair 116c and the roller pair 146a close to the center [C] are made small and the friction force is made small, so that the conveyance force of the sheet P close to the center [C] may be made smaller than the conveyance force at both sides.

What is claimed is:

1. A sheet skew correcting device comprising:
a first sheet conveyance unit which has a drive rotating first rotator and a second rotator to nip a sheet together with the first rotator and to be driven, and in which a conveyance force at a center side in a traveling direction of the sheet is smaller than a conveyance force at a first side in the traveling direction;
a second sheet conveyance unit which has a drive rotating third rotator and a fourth rotator to nip the sheet together with the third rotator and to be driven, which is adjacent to the first sheet conveyance unit across the center in the traveling direction of the sheet, and a conveyance force at the center side in the traveling direction of the sheet is smaller than a conveyance force at a second side in the traveling direction;
a first drive unit to drive the first rotator;
a second drive unit to drive the third rotator;
a detection unit to detect an inclination of the sheet; and
a control unit to control the first drive unit and the second drive unit based on a detection result of the detection unit.

2. The device of claim 1, wherein the first sheet conveyance unit includes a first pressing unit to press the second rotator to the first rotator and a pressing force of the first pressing unit at the center side is smaller than a pressing force at the first side,
the second sheet conveyance unit includes a second pressing unit to press the fourth rotator to the third rotator, and a pressing force of the second pressing unit at the center side is smaller than a pressing force at the second side.

3. The device of claim 2, wherein the first rotator includes a plurality of first rollers, the second rotator includes a plurality of second rollers respectively opposite to the plurality of first rollers, the first pressing unit includes a plurality of first springs to respectively press the plurality of second rollers to the plurality of first rollers,
the third rotator includes a plurality of third rollers, the fourth rotator includes a plurality of fourth rollers respectively opposite to the plurality of third rollers, and the second pressing unit includes a plurality of second springs to respectively press the plurality of fourth rollers to the plurality of third rollers.

4. The device of claim 3, wherein the second rotator includes a plurality of first support frames to respectively support the plurality of second rollers and to rotate while using a first shaft as a fulcrum and the plurality of first springs respectively press the plurality of first support frames to the plurality of first rollers,
the fourth rotator includes a plurality of second support frames to respectively support the plurality of fourth rollers and to rotate while using a second shaft as a fulcrum, and the plurality of second springs respectively press the plurality of second support frames to the plurality of third rollers.

5. The device of claim 1, wherein a friction force of the first sheet conveyance unit to the sheet at the center side in the traveling direction of the sheet is smaller than a friction force at the first side in the traveling direction, and
a friction force of the second sheet conveyance unit to the sheet at the center side in the traveling direction of the sheet is smaller than a friction force at the second side in the traveling direction.

6. The device of claim 5, wherein the first rotator includes a plurality of first rollers, the second rotator includes a plurality of second rollers respectively opposite to the plurality of first rollers, widths of the plurality of first rollers and the plurality of second rollers become small from the first side toward the center side,
the third rotator includes a plurality of third rollers, the fourth rotator includes a plurality of fourth rollers respectively opposite to the plurality of third rollers, and widths of the plurality of third rollers and the plurality of fourth rollers become small from the second side toward the center side.

7. A sheet conveying device comprising:
a first sheet conveyance unit which has a drive rotating first rotator and a second rotator to nip a sheet together with the first rotator and to be driven, and in which a conveyance force at a center side in a traveling direction of the sheet is smaller than a conveyance force at a first side in the traveling direction;
a second sheet conveyance unit which has a drive rotating third rotator and a fourth rotator to nip the sheet together with the third rotator and to be driven, which is adjacent to the first sheet conveyance unit across the center in the traveling direction of the sheet, and a conveyance force at the center side in the traveling direction of the sheet is smaller than a conveyance force at a second side in the traveling direction;
a first drive unit to drive the first rotator according to an inclination of the sheet; and
a second drive unit to drive the third rotator according to the inclination of the sheet.

8. The device of claim 7, wherein the first sheet conveyance unit includes a first pressing unit to press the second rotator to the first rotator and a pressing force of the first pressing unit at the center side is smaller than a pressing force at the first side,
the second sheet conveyance unit includes a second pressing unit to press the fourth rotator to the third rotator, and a pressing force of the second pressing unit at the center side is smaller than a pressing force at the second side.

9. The device of claim 8, wherein the first rotator includes a plurality of first rollers, the second rotator includes a plurality of second rollers respectively opposite to the plurality of first rollers, the first pressing unit includes a plurality of first springs to respectively press the plurality of second rollers to the plurality of first rollers,
the third rotator includes a plurality of third rollers, the fourth rotator includes a plurality of fourth rollers respectively opposite to the plurality of third rollers, and the second pressing unit includes a plurality of second springs to respectively press the plurality of fourth rollers to the plurality of third rollers.

10. The device of claim 9, wherein the second rotator includes a plurality of first support frames to respectively support the plurality of second rollers and to rotate while using a first shaft as a fulcrum and the plurality of first springs respectively press the plurality of first support frames to the plurality of first rollers,
the fourth rotator includes a plurality of second support frames to respectively support the plurality of fourth rollers and to rotate while using a second shaft as a fulcrum, and the plurality of second springs respectively press the plurality of second support frames to the plurality of third rollers.

11. The device of claim 7, wherein a friction force of the first sheet conveyance unit to the sheet at the center side in the traveling direction of the sheet is smaller than a friction force at the first side in the traveling direction,
a friction force of the second sheet conveyance unit to the sheet at the center side in the traveling direction of the sheet is smaller than a friction force at the second side in the traveling direction.

12. The device of claim 11, wherein the first rotator includes a plurality of first rollers, the second rotator includes a plurality of second rollers respectively opposite to the plurality of first rollers, widths of the plurality of first rollers and the plurality of second rollers become small from the first side toward the center side,
the third rotator includes a plurality of third rollers, the fourth rotator includes a plurality of fourth rollers respectively opposite to the plurality of third rollers, and widths of the plurality of third rollers and the plurality of fourth rollers become small from the second side toward the center side.

13. An image forming apparatus comprising:
an image forming unit to form a toner image on an image carrier;
a plurality of roller pairs which nip a sheet and in which a conveyance force at a center side in a traveling direction of the sheet is smaller than a conveyance force at an outside in the traveling direction; and
a transfer unit to transfer the toner image to the sheet conveyed by the plurality of roller pairs.

14. The apparatus of claim 13, wherein a mutual pressing force of the roller pair at the center side is smaller than a mutual pressing force of the roller pair at the outside.

15. The apparatus of claim 14, wherein the plurality of roller pairs include springs to press mutually, and a pressing force of the spring of the roller pair at the center side is smaller than a pressing force of the spring of the roller pair at the outside.

16. The apparatus of claim 13, wherein a friction force of the roller pair at the center side is smaller than a friction force of the roller pair at the outside.

17. The apparatus of claim 13, wherein a width of the roller pair at the center side is smaller than a width of the roller pair at the outside.

18. A sheet skew correcting method, comprising:
causing a first conveyance force to a sheet between a center in a traveling direction of the sheet and a first side to become small from the first side toward the center side;
causing a second conveyance force to the sheet between the center of the sheet and a second side to become small from the second side toward the center side;
detecting an inclination of the sheet;
controlling a conveyance speed of the sheet between the center and the first side according to the inclination of the sheet; and
controlling a conveyance speed of the sheet between the center and the second side according to the inclination of the sheet.

19. The method of claim 18, wherein the first conveyance force is generated by a drive rotating first rotator and a second rotator to nip the sheet together with the first rotator and to be driven and rotated, and
the second conveyance force is generated by a drive rotating third rotator and a fourth rotator to nip the sheet together with the third rotator and to be driven and rotated.

20. The method of claim 19, wherein pressing forces of the first rotator and the second rotator are made small at the center side as compared with the first side, and pressing forces of the third rotator and the fourth rotator are made small at the center side as compared with the second side.

21. The method of claim 19, wherein a friction coefficient of the first rotator or the second rotator is made small at the center side as compared with the first side, and
a friction coefficient of the third rotator or the fourth rotator is made small at the center side as compared with the second side.
